(19) United States
(12) Patent Application Publication
(10) Pub. No.: US 2017/0066281 A1
(43) Pub. Date: Mar. 9, 2017

(54) WRITING BOARD

(71) Applicant: LOGAN WOLF PROPERTIES PTY LTD, Gosford (AU)

(72) Inventors: Ian Henry LOGAN, Gosford (AU); Patti Carol WOLF, Gosford (AU)

(21) Appl. No.: 15/068,453

(22) Filed: Mar. 11, 2016

Related U.S. Application Data
(63) Continuation-in-part of application No. PCT/AU14/00911, filed on Sep. 12, 2014.

(51) Int. Cl. B43L 1/00

(52) U.S. Cl. CPC B43L 1/00; B43L 1/008

(57) ABSTRACT

A writing board for mounting to a structure includes a main panel made from transparent material, the main panel having a front writing surface and a rear surface. There is at least one holding device formed in the rear surface for holding a background material. The front writing surface is flat and the entire background material is completely visible through the main panel.

### CROSS-REFERENCE TO RELATED APPLICATIONS

The present application is a continuation-in-part application under 35 U.S. Code Section 120 and Section 365 (c) of International application PCT/AU14/00911 with an international filing date of 12 Sep. 2014, and entitled “IMPROVED WRITING BOARD”, presently pending.

See also Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention relates to a writing board, specifically an improved glass whiteboard.

2. Description of Related Art Including Information Disclosed under 37 CFR 1.97 and 37 CFR 1.98

Whiteboards are typically white, glossy surface boards for non-permanent markings and writing. Recently, whiteboards have been made from glass as it provides a more sleek and frameless design compared to traditional whiteboards and blackboards. Glass whiteboards when mounted onto a wall provide a professional looking design and can be custom made to any shape and size.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a writing board for mounting to a structure, the mounting board comprising:
at least one holding means for receiving a background material, wherein at least a portion of the writing board in front of the background material in use allows light to pass therethrough such that at least a portion of the background material is visible in use, wherein the holding means comprises an opening adjacent an edge of the writing board to allow for insertion and removal of the background material into and from the holding means when the writing board is mounted to a structure.

In one preferred embodiment, the writing board comprises a main panel and where the background material is visible through the main panel.

In another preferred embodiment, the main panel is transparent or translucent

In another preferred embodiment, the main panel is transparent and made from glass material.

In another preferred embodiment, each holding means is formed along a rear surface of the main panel.

In another preferred embodiment, each holding means extends between side edges of the main panel.

In another preferred embodiment, each holding means comprises at least one slot-shaped opening adjacent a side edge.

In another preferred embodiment, each holding means is dimensioned to receive a planar background material up to a maximum thickness of about 15 mm.

In another preferred embodiment, the writing board comprises at least two holding means.

In another preferred embodiment, the holding means are formed in a substantially contiguous arrangement.

In another preferred embodiment, the at least one holding means is spaced from a top edge of the main panel to define a top display section.

In another preferred embodiment, the at least one holding means is spaced from a bottom edge of the main panel to define a bottom display section.

In another preferred embodiment, each holding means is a pocket is formed by spaced rods mounted to a rear surface of the main panel and a backing panel mounted to the rods.

In another preferred embodiment, the backing panel comprises at least one inwardly curved side edge for each pocket.

In another preferred embodiment, the at least one pocket extends over a section only of the writing board.

In another preferred embodiment, the writing board comprises at least one metallic or magnetic section.

In another preferred embodiment, the writing board comprises a main panel and at least one metal plate mounted to a rear surface of the main panel to form the at least one metallic or magnetic section.

In another aspect, the present invention provides a writing board for mounting to a structure, comprising:
a main panel made from transparent material, the main panel having a front writing surface and a rear surface, the front writing surface being flat between edges of the main panel; and
at least one holding means formed in the rear surface for holding a background material, the entire background material being visible through the main panel in use.

In a preferred embodiment, the holding means comprises an opening adjacent a side edge of the writing board to allow for insertion and removal of the background material into and from the holding means when the writing board is mounted to a structure.

In another preferred embodiment, the writing board comprises at least one metal or magnetic plate mounted to the rear surface of the main panel to form at least one metallic or magnetic section.

In another preferred embodiment, each holding means is a pocket is formed by spaced upper and lower mounting blocks mounted to a rear surface of the main panel and a backing panel mounted to the rods, the upper and lower mounting blocks being aligned with respective upper and lower edges of the main panel, and the backing panel being co-extensive with the main panel.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a front perspective view of a writing board in accordance with a first preferred embodiment of the present invention.

FIG. 2 is a rear perspective view of the writing board of FIG. 1 showing the insertion of a background sheet into a pocket.

FIG. 3 shows front elevation views of a number of writing boards similar to that shown in FIG. 1 mounted to a wall.

FIG. 4 shows a perspective view of the application of double-sided tape to a rod for forming the pockets of the writing board of FIG. 1.

FIG. 5 shows a perspective view of the mounting of rods to a rear surface of the main panel of the writing board of FIG. 1.

FIG. 6 shows a perspective view of the mounting of backing panels to the rods for forming the pockets of the writing board of FIG. 1.

FIG. 7 shows a front elevation view of a writing board in accordance with a second preferred embodiment of the present invention.

FIG. 8 shows a front elevation view of the magnetic sections of the writing board of FIG. 7.

FIGS. 9, 10 and 11 show schematic views of the steps in forming the magnetic sections of the writing board of FIG. 7.

FIGS. 12 and 13 show perspective views of a modified embodiment of the writing board.

### DETAILED DESCRIPTION OF THE INVENTION

It should be noted in the following description that like or the same reference numerals in different embodiments denote the same or similar features.

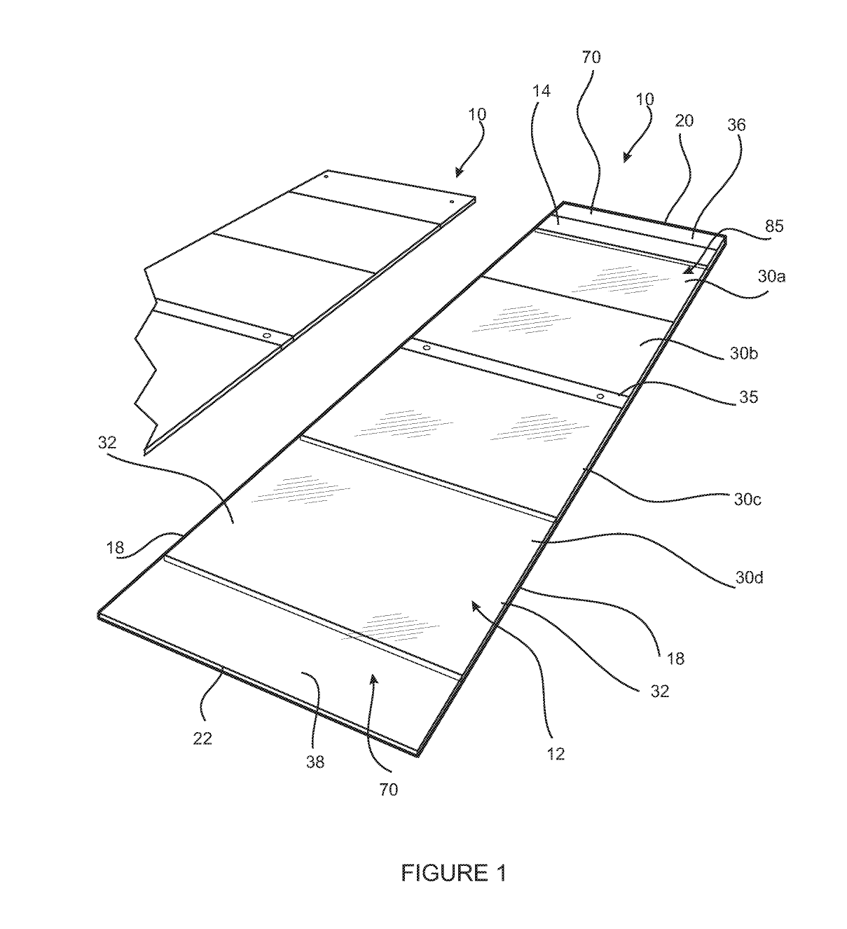

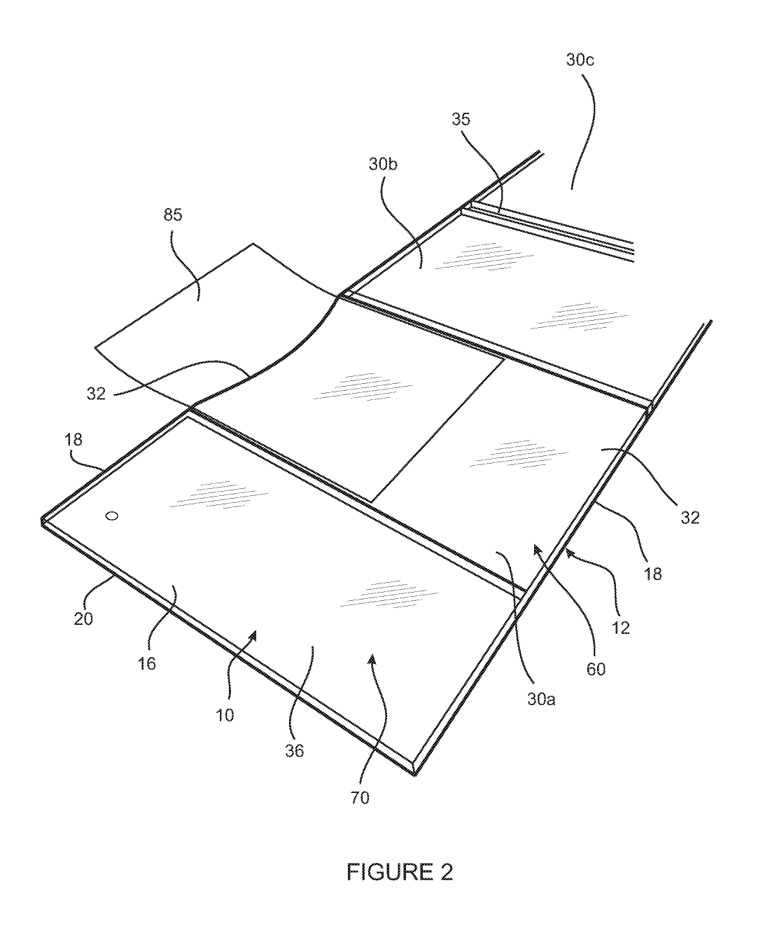

FIGS. 1 and 2 show a writing board 10 according to a preferred embodiment. The writing board 10 comprises an elongated rectangular front main panel 12 made from a material which allows light to pass through (i.e. transparent or translucent). In the embodiment, the main panel 12 is transparent and made from glass material. The main panel 12 can alternatively be made from transparent plastics material. The main panel 12 comprises a front surface 14, rear surface 16, side edges 18, a top edge 20 and a bottom edge 22. The main panel comprises a fully flat front surface 14 which extends between the edges 18 to 22 thereof.

The writing board 10 further comprises four pockets 30a to 30d arranged in a row along the rear surface 16 of the main panel 12. The pockets 30a to 30d are formed in a substantially contiguous arrangement along the length of the main panel 12, spaced from both the top edge 20 and the bottom edge 22. The first and second pockets 30a and 30b are contiguous and spaced by a middle band section 35 from contiguous third and fourth pockets 30c and 30d. Each pocket 30 extends between the side edges 18 and terminates at the side edges 18.

A top section 36 is defined between the top edge 20 and the first pocket 30a and a bottom section 38 is defined between the bottom edge 22 and the fourth pocket 30d.

Each pocket 30 comprises elongated slot-shaped openings 32 adjacent a respective side edge 18. Each pocket 30 is dimensioned to removably receive therein a background sheet material 85, in the embodiment being an A3 size paper. Each pocket 30 is dimensioned to receive a sheet material or cardboard material typically between 1 to 3 mm and up to a maximum thickness of about 15 mm. The background sheet 85 is easily removable and replaceable with another sheet as needed via the openings 32.

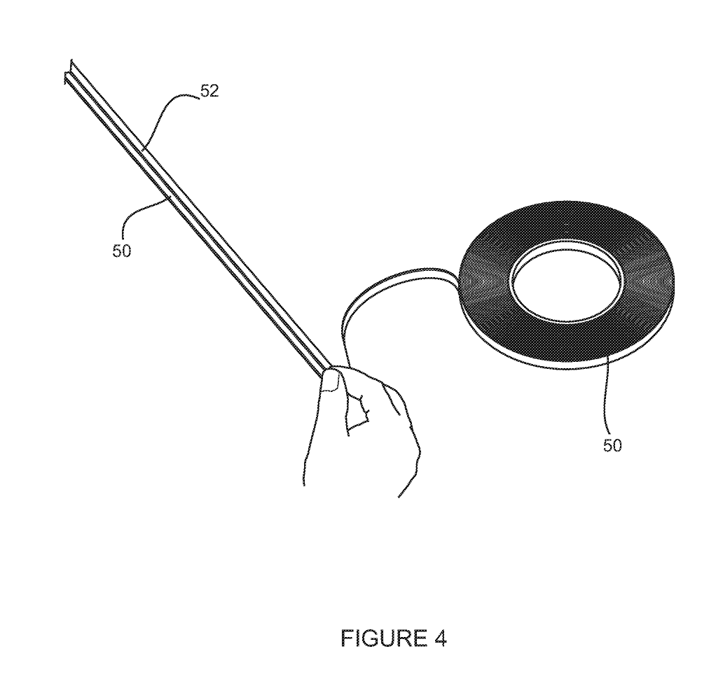

FIGS. 4 to 6 show how the pockets 30 are formed. Referring to FIG. 4, respective lengths of double-sided tape 50 is applied to opposite sides of a rod 52. The rod is made from Perspex material and preferably provides flat opposing sides to which the tape 50 is attached.

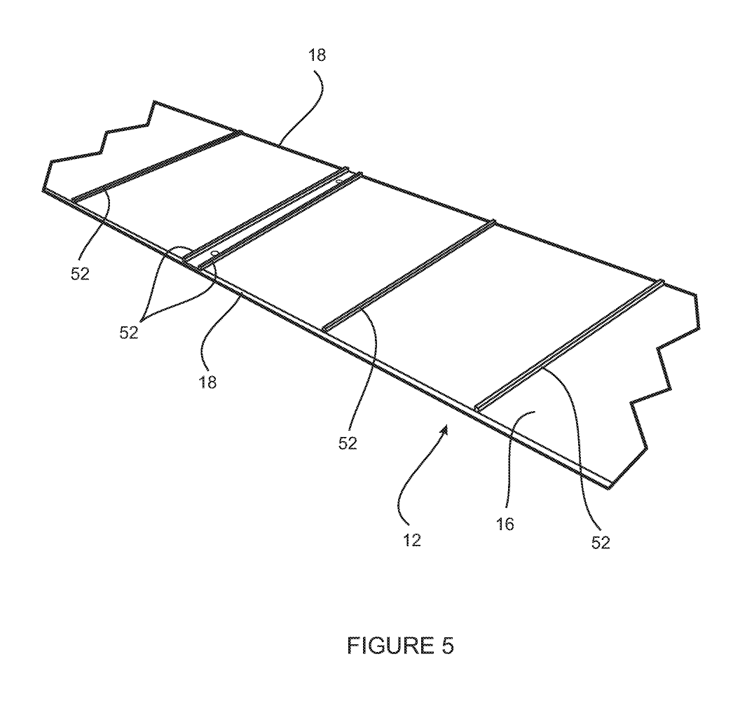

Referring to FIG. 5, taped rods 52 are mounted to the rear surface 16 of the main panel 12. Each rod 52 extends between the side edges 18 and are parallel to each other, and to the top and bottom edges 20 and 22. The specific distance between each pair of adjacent rods 52 defines the height of each pocket 30. The double-sided tape 50 forms lines at the front surface 14 and are thus of a desired line colour. Suitable coloured material can be used or added to provide the desired line finish, such as vinyl material or other coloured or patterned material.

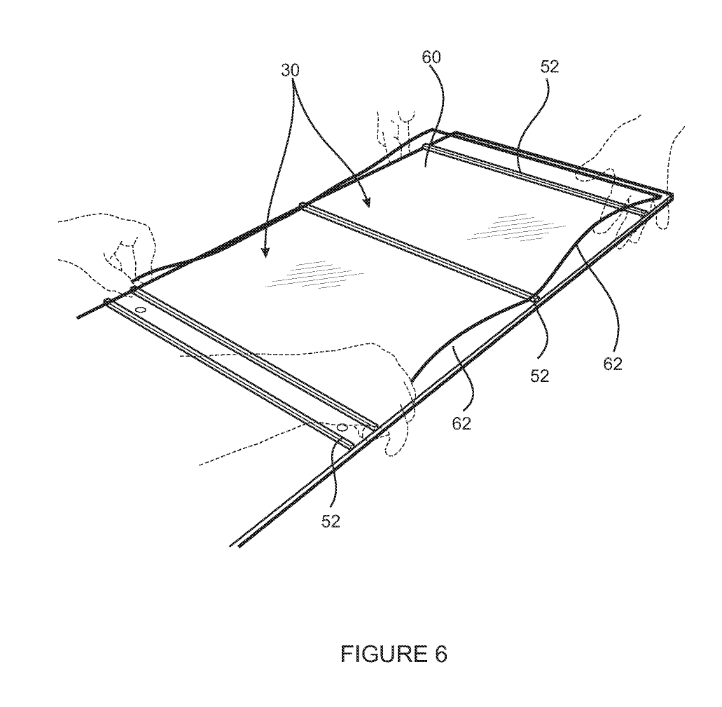

Referring to FIG. 6, a backing panel 60 made from plastics (Perspex) material is mounted to the rods 52. Each backing panel 60 spans the length of two adjacent pockets 30, and is thus mounted to three of the rods 52. Two backing panels 60 are thus used for the writing board 10 to form the four pockets 30. Alternatively, a separate backing panel 60 can be used for each respective pocket 30. Each backing panel 60 extends between the side edges 18 and terminates at the side edges 18.

The backing panel 60 comprises an inwardly curved side edge 62 (at one side edge) for each pocket 30 to allow for easy insertion into and removal of a sheet material 85 from the pocket 30.

In use, as shown in FIGS. 1 and 2, the writing boards 10 are typically mounted to a structure such as a wall. Alternatively, the writing board 10 can be mounted to a movable structure such as a movable stand. It is also possible to mount the writing board 10 horizontally to form a writing table. A customised coloured and/or printed backing material 70 can be mounted to the top section 36 and the bottom section 38. The backing material 70 in the embodiment is customised printed vinyl material which is adhered to the rear surface 16 of the main panel 12.

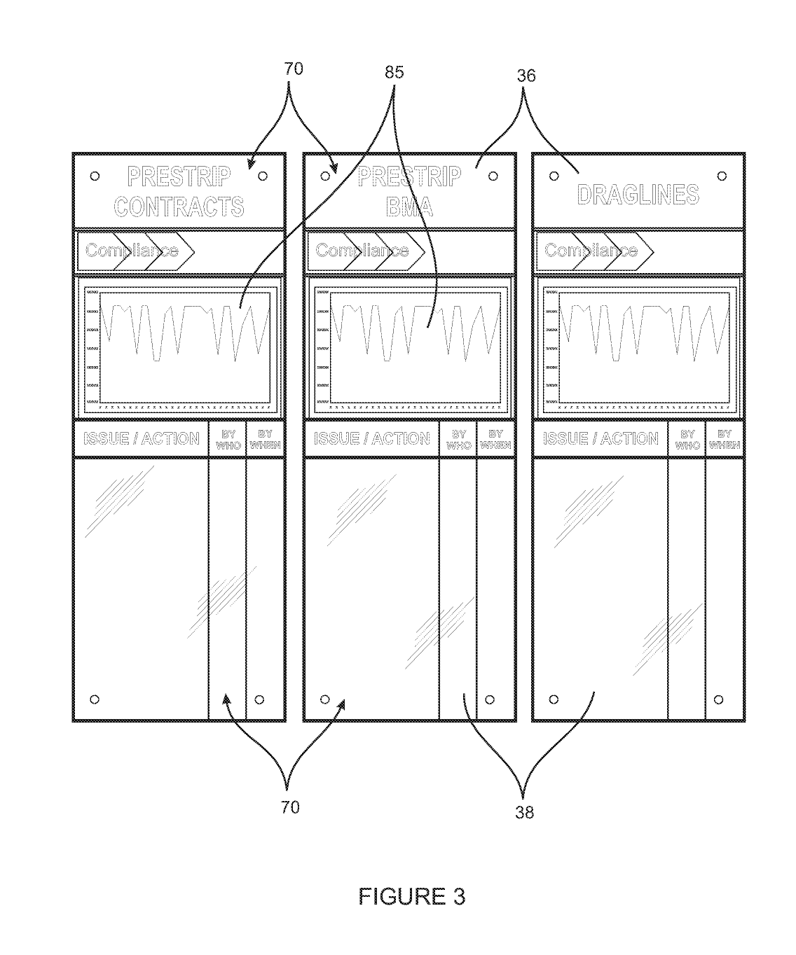

Printed sheet material 85 (FIGS. 2 and 3) can then be inserted into the pockets 30. The sheet material 85 can be easily inserted and removed via the openings 32, and can be replaced as needed.

As the main panel 12 is transparent, the graphic or writing of the backing material 70 and the printed sheet material 85 are viewable through the main panel 12. Users can then use marker pens to write or draw onto the front surface 14 of the main panel 12 as required. The front surface 14 is completely flat and there are no edges or recesses to hinder users writing thereon.

In the example shown in FIG. 3, each writing board 10 comprises only a single pocket 30. The top section 36 and the bottom section 38 are larger in these examples. The pocket 30 receives a printed sheet material 85 which is used as a reference (for example a graph of past or expected performance), and where current performance is tracked by writing on the front surface 14.

In another embodiment, the writing board 10 can be dimensioned to have one pocket 30 only for a specific paper size, for example A4 or A3 paper.

The present invention provides a replaceable background writing board, it that it allows for a customized and easily changeable background material to be added to the writing board 10 which can be used as reference or for any other desired purpose. The entire background material is visible and there are no portions of the background material that is blocked by any section of the main panel. The background material can be any generally planar material such as plain or printed paper, a poster, a cardboard sheet and the like, or it can be a contoured or shaped item. The background material can simply be for display and thus the invention also provides a combined display and writing board.

Whilst preferred embodiments of the present invention have been described, it will be apparent to skilled persons that modifications can be made to the embodiments described. For example, the writing board 10 can be made in any size and the pockets 30 can also be made to accommodate any size sheet material such as A4, A2, A1 or A0. The backing material 70 and the printed sheet material 85 can also be customised as per customer requirements. The means for holding the background sheet can also be embodied in other forms, such as by having lower and/or upper rails or slots into which substantially rigid/stiff background material can be mounted by inserting and sliding along the rails or slots.

It is also possible for the writing board 10 to be formed by having co-extensive parallel panels mounted via spaced rods therebetween. The rods can also be replaced with wider mounting blocks if desired. It is also possible for the pockets to be formed on the front surface 14, with the backing panel 60 attached to the front and which can be made from glass material.

A pocket can also be formed adjacent the top edge which can have an opening at the top edge rather than at the side edge thereof. Each pocket can also have a closed edge and only one opening to assist in retaining the sheet material therein.

A pair of pockets can be formed side by side, each pocket in the pair having its respective opening at a respective side edge thereof. The pockets can both terminate at the middle where they meet, by having a vertical divider rod mounted thereon.

The pockets also do not have to be contiguous, and can be spaced from each other. The pockets can also be disposed in a pattern, such as in a circular arrangement.

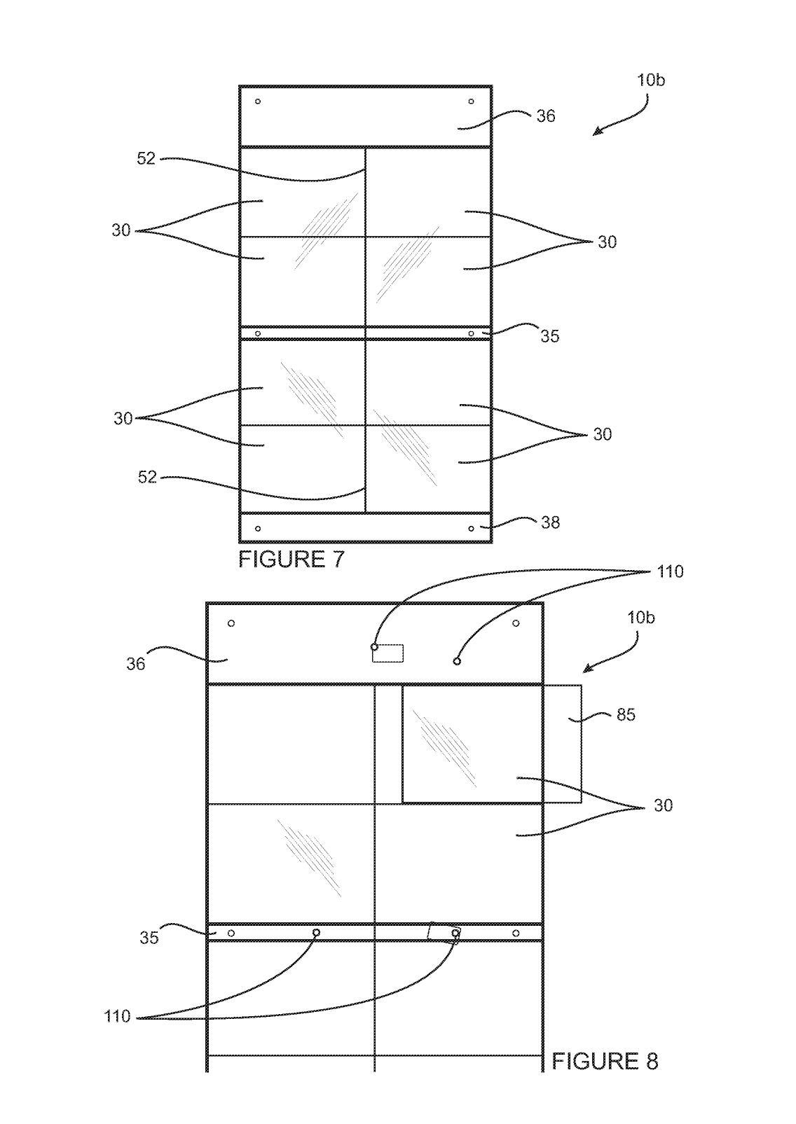

The writing board 10 can be made in any size with any number of pockets, such as an 8-pocket variation shown in FIG. 7.

FIG. 7 shows a writing board 10b according to another embodiment, which comprises pockets 30 arranged in a 4×2 array. In this embodiment, the writing board 10b has four pairs of two side by side pockets 30. The writing board 10b holds 4×A3 paper in the upper pockets 30, and 4×A3 paper in the bottom pockets 30. One or more vertical divider rods 52b are disposed between each pair of pockets 30 to act as a central stop for the background sheets 85. The upper pockets 30 and lower pockets 30 are separated by a central band section 35.

The writing board 10b further comprises metallic sections formed in the top section 36, bottom section 38 and the central band 35 which allows magnets to be mounted to these sections. As shown in FIG. 8, magnetic buttons 110 can be attached to these metallic/magnetic sections for mounting notes or other items to the writing board 10b.

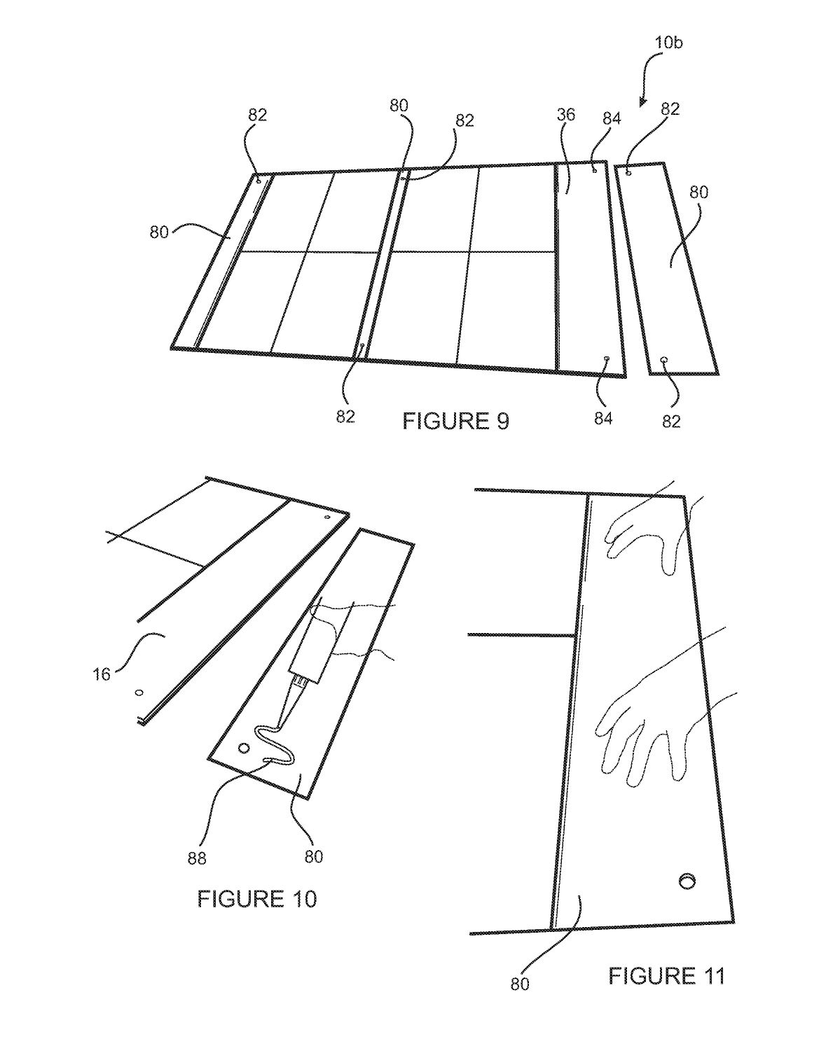

FIGS. 9 to 11 show the steps in forming the magnetic sections of the writing board of FIG. 7. Respective metal plates 80 are cut to size for the top section 36, bottom section 38 and the central band 35, with the plates 80 having apertures 82 formed therein which align with mount apertures 84 of the writing board 10b. The plates 80 are then attached to their respective sections, at the rear surface 16 of the main panel 12, via silicon adhesive 88. Once the adhesive 88 cures, magnetic buttons 120 and other magnetic items can be mounted to the front surface 14 of the main panel 12 at the metallic/magnetic sections 35, 36 and 38. The metal plates can also be replaced with magnetic strips.

As the pockets 30 and the magnetic sections are formed along the rear surface 16 of the main panel 12, the front surface 14 is free from any obstruction. Although less preferred, the backing panels 60 can be mounted to the front surface 14, with the backing panels forming a writing surface. The plates 80 can also be attached to the front surface 14. The plate 80 can also be replaced with a magnetic strip for attaching metal pins or plates to the writing board.

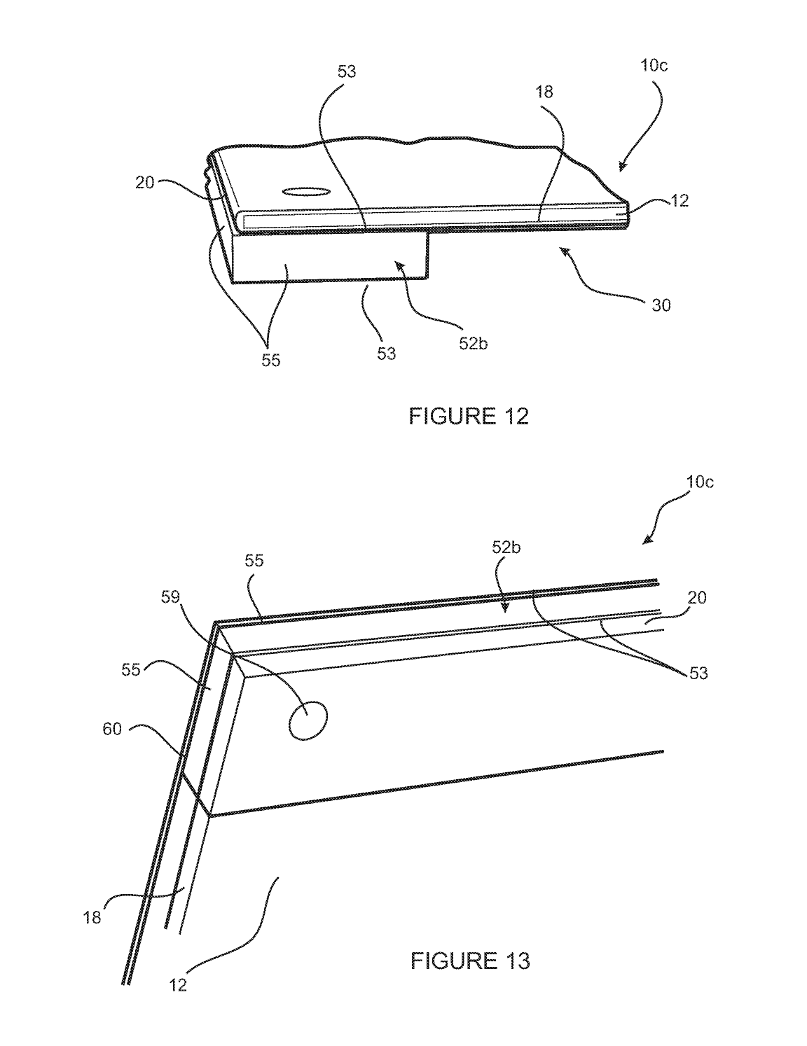

FIGS. 12 and 13 show a writing board 10c according to another embodiment. The writing board 10c also comprises a rectangular front main panel 12 which is also made from glass or transparent plastics material. The writing board 10c also defines at least one pocket 30 dimensioned to receive a sheet material.

Each pocket 30 in this embodiment is formed using rectangular blocks 52b which replace the rods 52 in the other embodiments above. Each block 52b is made from Perspex material and is 1.5 to 3 mm thick, preferably 2 mm. Each block 52 provides flat opposed sides 53 for attachment to the main panel 12 and the backing panel 60.

Each block 52 is disposed adjacent the top edge 20 or bottom edge 22 of the main panel 12. Each block 52b comprises edge faces 55 which are aligned with the respective top edge 20 or bottom edge 22, and the side edges 18 of the main panel 12. The backing panel 60 is mounted to the blocks 52b, with the backing panel edges aligned with the edges of the main panel 12. Fasteners for mounting the writing board 10c to a structure will extend through mount apertures 59 which extends through the main panel 12, block 52b and the backing panel 60.

The block 52b which extends to the side edges 18 and top edge 20 or bottom edge 22 provides easy to clean edges which does not allow dust to collect in an inaccessible location. The backing panel 60 is co-extensive as the main panel 12 (edge to edge and top to bottom). The writing board 10c provides edges which are aligned and where no recesses are formed (the panels and mounting block edges are flush with each other at least at the top and lower edges), which is easy to clean and is thus suitable for use in clean spaces such as hospitals.

1. A writing board for mounting to a structure, said writing board comprising:
a writing board body; and
at least one holding means for receiving a background material, wherein at least a portion of the writing board body in front of the background material in use allows light to pass therethrough such that at least a portion of the background material is visible in use, wherein the holding means comprises an opening adjacent an edge of the writing board body to allow for insertion and removal of the background material into and from the holding means when the writing board body is mounted to a structure.

2. The writing board of claim 1, further comprising: a main panel, said background material being visible through the main panel.

3. The writing board of claim 2, wherein the main panel is transparent and is comprised of glass material.

4. The writing board of claim 2 wherein each holding means is formed along a rear surface of the main panel.

5. The writing board of claim 2 wherein each holding means extends between side edges of the main panel.

6. The writing board of claim 2 wherein each holding means comprises at least one slot-shaped opening adjacent a side edge.

7. The writing board of claim 2 wherein each holding means is dimensioned to receive a planar background material up to a maximum thickness of about 15 mm.

8. The writing board of claim 1, further comprising: at least another holding means.

9. The writing board of claim 8 wherein the holding means are formed in a substantially contiguous arrangement.

10. The writing board of claim 2 wherein the at least one holding means is spaced from a top edge of the main panel to define a top display section.

11. The writing board of claim 2 wherein the at least one holding means is spaced from a bottom edge of the main panel to define a bottom display section.

12. The writing board of claim 2, wherein each holding means is comprised of a pocket is formed by spaced rods mounted to a rear surface of the main panel and a backing panel mounted to the rods.

13. The writing board of claim 13 wherein the backing panel comprises at least one inwardly curved side edge for each pocket.

14. The writing board of claim 1, further comprising: at least one pocket extending over a section only of the writing board body.

15. The writing board of claim 1, further comprising at least one metallic or magnetic section.

16. The writing board of claim 15, further comprising a main panel and at least one metal plate mounted to a rear surface of the main panel to form the at least one metallic or magnetic section.

17. A writing board for mounting to a structure, comprising:
a main panel comprised of a transparent material, the main panel having a front writing surface and a rear surface, the front writing surface being flat between edges of the main panel; and
at least one holding means formed in the rear surface for holding a background material, the entire background material being visible through the main panel in use.

18. The writing board of claim 17, wherein the holding means comprises an opening adjacent a side edge of the main panel to allow for insertion and removal of the background material into and from the holding means when mounted to a structure.

19. The writing board of claim 17 comprising at least one metal or magnetic plate mounted to the rear surface of the main panel to form at least one metallic or magnetic section.

20. The writing board of claim 17, wherein each holding means is comprised of a pocket is formed by spaced upper and lower mounting blocks mounted to a rear surface of the main panel and a backing panel mounted to the rods, the upper and lower mounting blocks being aligned with respective upper and lower edges of the main panel, and the backing panel being co-extensive with the main panel.
